(19) United States
(12) Patent Application Publication
(10) Pub. No.: US 2023/0086880 A1
(43) Pub. Date: Mar. 23, 2023

(54) CONTROLLABLE IMAGE-BASED VIRTUAL TRY-ON SYSTEM

(71) Applicants: Kedan Li, Montreal (CA); Jeffrey Zhang, Pleasanton, CA (US)

(72) Inventors: Kedan Li, Montreal (CA); Jeffrey Zhang, Pleasanton, CA (US)

(73) Assignee: Revery.ai, Inc.

(21) Appl. No.: 17/948,070

(22) Filed: Sep. 19, 2022

Related U.S. Application Data
(60) Provisional application No. 63/245,935, filed on Sep. 20, 2021.

(51) Int. Cl. G06T 11/00; G06T 7/10; G06T 7/73

(52) U.S. Cl. CPC G06T 11/00; G06T 7/10; G06T 7/73; G06T 2200/24; G06T 2210/16; G06T 2207/20021; G06T 2207/30196; G06T 2210/44; G06T 2207/20081; G06T 2207/20084

(57) ABSTRACT

The invention concerns a method and a system of generating high-resolution digital try-on images of human models wearing arbitrary combinations of garments and shoes with faithfully represented spatial interrelationships and transformations using a system of neural networks. The method allows for a realistic representation and combination of neutral garment images from different sources on a human body model and has a potential for commercial use in online shopping experiences. The input of the system is 2D human body, garment, and shoe images. The method involves adjusting the human body to the position of the shoes, taking steps to create a controllable intermediate representation that predicts the garments' position and deformation on the body, and creating a semantic layout of the body wearing the garments. The method allows for adjusting the position and the dimension of every garment, including the creation of tucked-in tops and open or closed outerwear.

### CROSS-REFERENCE TO RELATED APPLICATIONS

This application claims the benefit of the U.S. Prov. Ser. No. 63/245,935 filed on Sep. 20, 2021. The application is incorporated by reference herein.

### BACKGROUND OF THE INVENTION

Fashion retail industry is going through a rapid transition from physical stores to e-commerce platforms. Despite the many advantages of online clothing stores, up until now, they have lacked an important shopping experience: the ability to mix and match garments and visualize garment combinations (“Outfits”) as worn by a human model. A virtual dressing room may restore this experience and significantly increase user engagement and online shopping conversion rates. However, the existing virtual try-on methods lack at least one of the following: scalability, affordability, faithful representation, ability to mix and match garments, and change human models and garments in real-time.

The traditional way of implementing a virtual try-on experience by rendering 3D models of the items onto 3D body models through physic engines is not scalable and not suitable when working with a variety of garments.

Existing image warping technology creates imperfect output images because the feature maps give relatively sparse information about the distortions in a warp. A way to address this issue is by incorporating 3D priors. However, this method results in biases that distort the output images because garments and poses are strongly correlated in the training data. For example, people wearing jackets are predicted to have significantly wider shoulders than people wearing shirts.

An alternative strategy is to provide a rich representation of where points lie on the source using encoded feature vectors or feature maps. These methods are unable to preserve structured spatial patterns, such as prints.

Single garment virtual try-on methods (SG-VITON) generally faithfully represent garment properties, can produce high quality images, and are scalable. However, that comes at the cost of working with a single garment of a single type (mostly tops).

Multi-garment virtual try-on (MG-VITON) is more challenging because one must ensure proper garments layering and interaction. Visual feature encoding used in the existing MG-VITON technology causes a loss of texture detail, which can be solved by fine-tuning the generator for every query, at the expense of scalability. Model control is not available, nor is garment swapping.

The industry demands high resolution imagery, but the existing technology operates at a relatively low resolution, which often results in inaccurate representation. Even the technology operating at a 1 k resolution using a residual architecture cannot faithfully represent garment properties.

Another important issue that the current invention proposes to solve is that existing technology mostly uses input images of garments as worn by humans, which requires that each garment be tried on by a model for a photo, which results in additional costs. This invention enables a virtual fitting process using neutral photographs of individual garments lying down/hanging on a hanger, which requires less time to produce, is less expensive, and more convenient.

### BRIEF SUMMARY OF THE INVENTION

The technology now will be described more fully hereinafter with reference to the accompanying drawings, in which some, but not all embodiments are shown. Indeed, the invention may be embodied in many different forms and should not be construed as limited to the embodiments set forth herein; rather, these embodiments are provided so that this disclosure will satisfy the applicable legal requirements.

Likewise, many modifications and other embodiments of the technology described herein will come to mind to one of skill in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of this disclosure. Although specific terms are employed herein, they are used in a generic and descriptive sense only and not for purposes of limitation.

Unless defined otherwise, all technical and scientific terms used herein have the same meaning as commonly understood by one of skill in the art to which the invention pertains. Although any methods and materials similar to or equivalent to those described herein can be used in the practice or testing of the technology, the preferred methods and materials are described herein.

The present invention, Controllable Image-Based Virtual Try-on System (CIVTS) enables convenient adjustments to the position and dimension of the garment on the person. The controllability is achieved by incorporating a layer of controllable intermediate representation guiding the position and dimension of the garment on the person. A controllable intermediate representation should contain sufficient information about a garment's position and deformation on a person and should be easily interpretable and manipulable. The preferred embodiment of this invention involves the use of a set of garment key points on a person as the controllable intermediate representation.

The CIVTS uses a database of human body representation and shoes representation and modifies the human body representation to complement the positioning of the shoes selected by the user. The system then uses a neutral garment representation and the updated body representation to predict the controllable intermediate representation of the garment on the person. The system allows for any necessary adjustment to the intermediate representation and uses the adjusted intermediate representation to predict the spatial transformation of the garment onto the person and further update the human body representation. The system uses the transformed garment and the updated the human body representation to synthesize the final image of the human model wearing a complete Outfit.

The system consists of several neural networks with parameters (Networks) specifically trained to perform the tasks, and a series of logical operations to utilize and manipulate the output of the neural networks. During the training phase, each of the Networks has its parameters learned through specialized training data and learning procedures. The parameters are then saved to be used during the inference phase.

The system uses the following procedures to create a try-on image. (1) The system swaps the shoes onto the model and computes the conceivable feet locations. In our preferred embodiment, we use the feet key points computed from the Feet Key Points Predictor Network. (2) The system computes the controllable intermediate representation of each garment that indicates its position and deformation on the model. In our preferred embodiment, the controllable intermediate representation is represented through key points predicted by the Garment Key Points Predictor Network. (3) The system observes the predicted controllable intermediate representation of all the garments and makes necessary adjustments to this representation based on the garment attributes, predicted positions of other items in the outfit, and user inputs. For example, the system creates a variation which narrows the torso part of the top if it is to be worn tucked in; the system may adjust the shape of an outerwear if it is to be worn closed or open; the system may adjust the shape of the dress or the skirt if it were to be covered by a long jacket, etc. (4) Then, the system iteratively generates an image of a model wearing a complete Outfit, with each iteration adding an additional garment. The process always starts from the garments beneath, with each additional garment layered over the previous one.

The first iteration starts with the original model image with the shoes replaced, if necessary, and its corresponding feature representation. The output of each iteration is a complete image with a garment being replaced, along with the corresponding feature representation. The output of each iteration can be treated as a final output or the input to a subsequent iteration. The image generation process runs as follows: (4a) The system masks out certain classes in the original semantic layout and uses the Layout Completion Network to produce the updated semantic layout based on the new garments. (4b) Because the produced garment layout does not capture the shape as well as the mask obtained from the warped garment, we take the garment layout from the warp and merge it with the rest of the predicted semantic layout through a set of specific operations, to obtain the final semantic layout. (4c) The system obtains the occluded image through the final semantic layout and the model image input. (4d) The system uses an image generator to generate the final image output.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 illustrates an overview of the procedures in the Controllable Image-Based Virtual Try-on System (CIVTS). The intermediate representation provides an easy way to adjust the shape and position of the warped garment on the person.

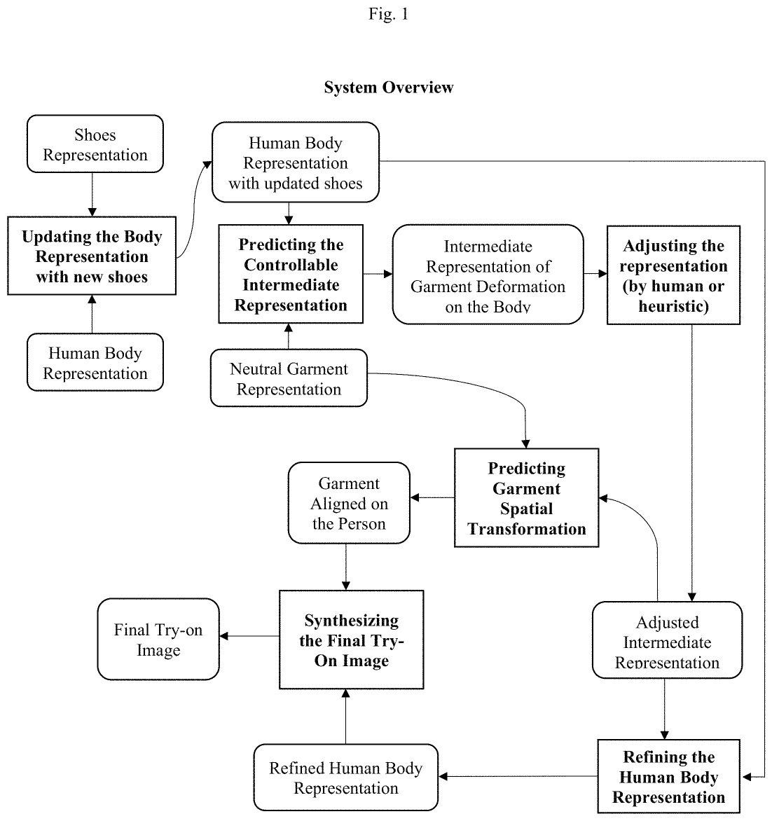

FIG. 2 illustrates the feature representation our system produces from the garment and the model.

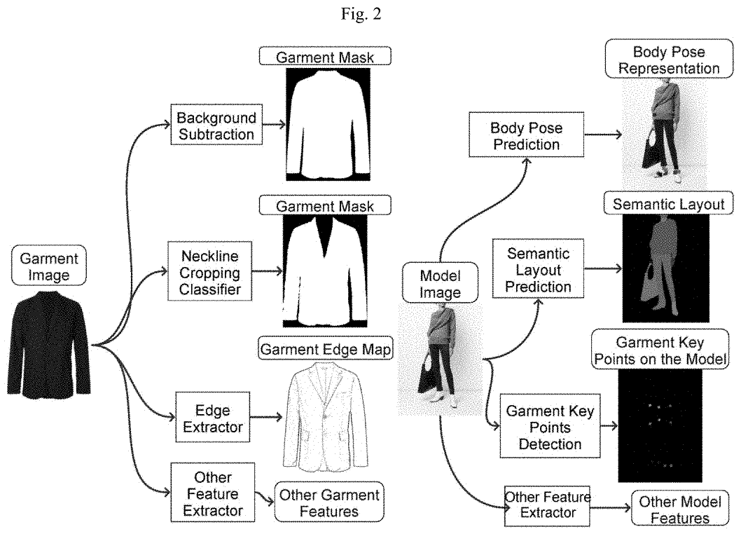

FIGS. 3a-3d show the training process of each neural network used by the try-on system. The dashed lines indicate the back propagation path during training.

FIG. 3a shows the training process of the Feet Pose Predictor Network.

FIG. 3b shows the training process of the Garment Key Point Predictor Network.

FIG. 3c shows the training process of the Layout Completion Network.

FIG. 3d shows the training process of the Warping Network.

FIG. 4 illustrates the overview of the Outfit generation process.

FIG. 5 illustrates the outfit data preparation process.

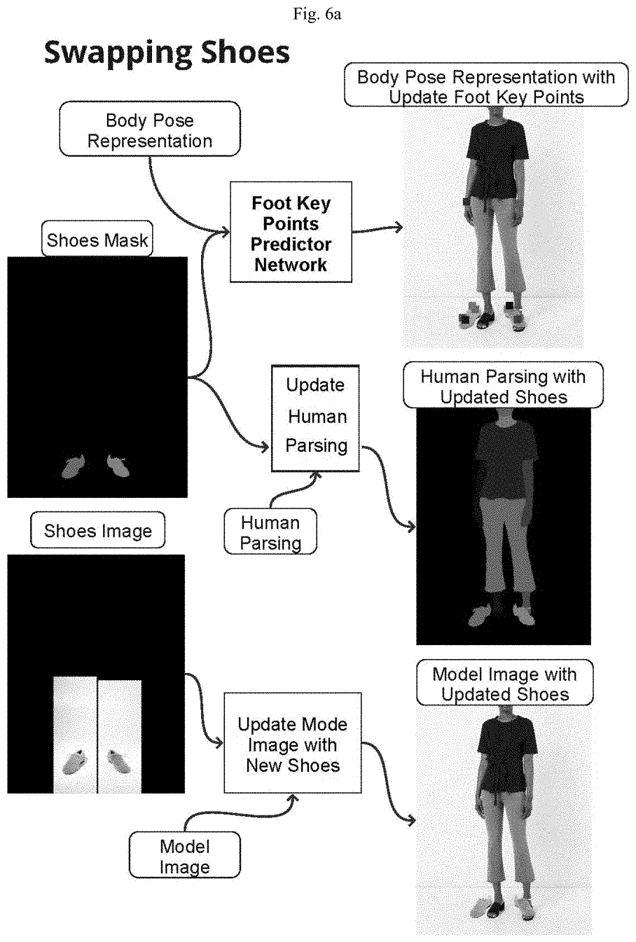

FIGS. 6a-6c show the process of swapping shoes and obtaining the adjustable key points of garment on the model.

FIG. 6a shows the process of swapping shoes.

FIG. 6b shows the process of predicting garment key points.

FIG. 6c shows the process of adjusting garment key points.

FIG. 7 illustrates an example of how key points are modified when the top is tucked in versus when the garment is not tucked in.

FIG. 8 illustrates how key points can be used to produce the appearance of an open and a closed outerwear.

FIG. 9 illustrates an example of how key point modifications can coordinate the shape of multiple garments to avoid errors in the rendering.

FIG. 10 illustrates the process of aligning every garment onto the model.

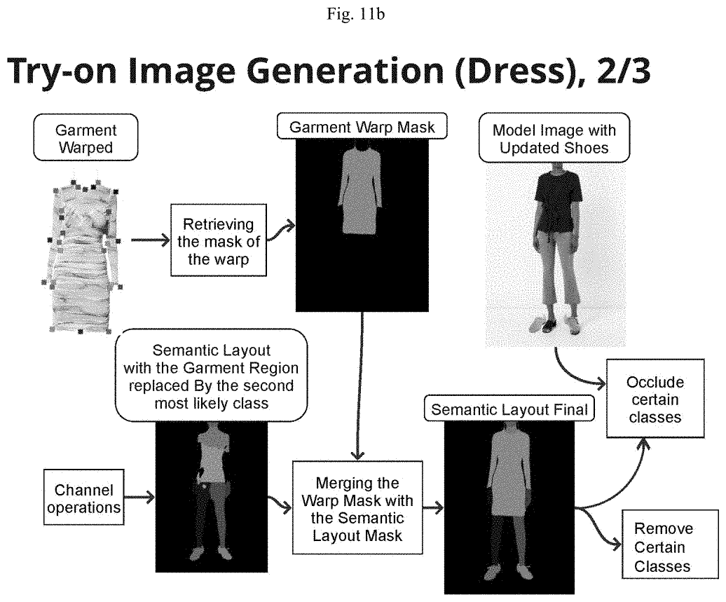

FIGS. 11a-11c illustrate the process of generating an image of a model wearing a garment. Note that this process is repeated several times to complete an Outfit consisting of multiple garments.

### NOTATIONS AND TERMS USED IN DESCRIPTION OF INVENTION AND IN RELATED FORMULAE

Neural Networks:
G_{f} Feet Pose Predictor Network
Gₖ Garment Key Points Prediction Network
Gₗ Layout Completion Network
G_{w} Warping Network
Gᵢ Image Generator Network

Feature Sets:
A Feature representations for a garment
B Feature representations for a person image
K Garment key points on the person
W Feature representations for warped garment (neutral garment aligned on the body)
Z Control parameters for Gₖ
\hat{K} Adjusted Garment Key Points on the person
θ Spatial transformation parameters

2D Tensor Attributes:
a neutral garment image
aₘ garment foreground mask
a_{c} garment mask with only visible regions
aₑ garment edge map
b full-body image the person wearing garment
bₘ semantic layout mask of the person wearing garment
[symbol] occluded semantic layout mask
\hat{b} occluded person image
bₘ^{g} semantic layout mask of garment
bₘ^{s} semantic layout mask of shoes
Bₘ output of Gₗ's last Softmax layer
bₚ body pose representation
bₚ^{f} feet key points of the body representation
bₚ^{f-} body representation without feet key points

Numerical and Categorical Features:
aₜ garment category
kᵢ key point
xᵢ horizontal coordinate of a key point
yᵢ vertical coordinate of a key point
i ith item in the set
n total number of items in the set
o size of an outfit
λᵢ training loss hyper parameters
N batch size
W width of 2D tensor
H height of 2D tensor

Functions or Logical Operations:
fₘ adjusting the garment key points through heuristics
f_{z} computing the control parameters for Gₖ
fₒ producing the occluded mask for semantic layout
f_{argmax}^{d=i} finding the max value index on dimension i
′ prediction made by a network from input data
″ prediction made by a network from predicted data
L training loss

A “controllable” intermediate representation is an intermediate representation that satisfies two properties: (1) the representation contains information that suggests the position and deformation of a garment on a body; (2) the representation can be manipulated by a human or an algorithm to represent a specific position and deformation that is intended. In the preferred embodiment, we use K Garment key points on the person as the controllable intermediate representation. It would be obvious for a person with ordinary skill in the art that there are other possible ways to construct a controllable intermediate presentation. For example, one can use lines or polygons instead of key points.

A semantic layout is a spatial representation that indicates the specific areas in an image for different regions of interests (such as different body components, clothing items and other articles). One example of a semantic layout is a pixel map. It would be obvious for a person with ordinary skill in the art that other examples are possible.

A spatial transform estimation procedure is a method that produces an exact spatial transformation from a garment onto a body. In the preferred embodiment, we use the Warping Network G_{w}.— an instance of a spatial transformer network that directly predicts the optical flow. It would be obvious for a person with ordinary skill in the art that there are other examples such as an affine warp predictor, a Thin-plate-spline warp predictor, etc.

A body pose predictor is a procedure that accepts feature representation and output a body pose representation. In the preferred embodiment, we use the Gf Feet Pose Predictor Network—an instance of body pose predictor that takes in a partial body pose representation and the representation of a pair of shoes placed as if someone is wearing them on a standing pose, and output a body pose presentation that align with the shoes. It would be obvious for a person with ordinary skill in the art that there are other examples of body pose predictor such as Open Pose, Dense Pose, etc.

An image generator is a procedure that accepts feature representations and directly outputs an image. In the preferred embodiment, we use the Gᵢ Image Generator Network—an instance of a U-Net with 6 layers as the image generator. It would be obviously for a person with ordinary skill in the art that there are other examples such a Residual Network, an Image Encoder-Decoder Network, etc.

### DETAILED DESCRIPTION OF THE INVENTION

Our controllable image-based virtual try-on system (CIVTS) enables control of the garment shape by introducing a controllable intermediate representation that suggests the garment position and deformation and can be easily manipulated. In the preferred embodiment, the controllable intermediate representation K takes the form of a set of key points K={k₁, k₂, . . . , kₙ}, kᵢ=(xᵢ, yᵢ), each represented by its x and y coordinates on the targeted person image. The controllable intermediate representation K is predicted through a Garment Key Points Predictor Network Gₖ based on neutral garment representations A and human body representations B. The key points K adjusted by a function M consist of heuristic and optional human intervention, resulting in the adjusted key points \hat{K}. A Warping Network G_{w} predicts a set of transformation parameters θ that aligns the neutral garment onto the person guided by the adjusted key points \hat{K}. We warp the garment image and the spatially aligned features through the predicted transformation parameters, resulting in the warped garment representations W. The skin region of the human parsing layout bₘ (part of the human body representation B) is also updated by the Layout Completion Network G₁ based on the updated garment key points \hat{K}, as some regions of skin may be covered or revealed due to the changes in K. Finally, the Image Generator Gᵢ takes in the warped garment w and the updated body representation B′ to produce the final image of the person wearing the garment.

Training Data.

Garment Features. The neutral garment representation A consists of a neutral garment image a taken when the garment is lying flat or worn by a mannequin and other features, as explained hereunder. Some features are directly derived from the image a. Some examples of these features include: (1) Garment Mask aₘ— a binary mask separating the garment region and the background region. (2) Cropped garment mask a_{c}— a binary mask where the region of the garment that was supposed to be covered by the human body (e.g., the collar, the back of the dress) is cropped out. (3) Edge Map aₑ— a binary edge map computed from the garment image that provides information for garment contour and shape. Other features are metadata that are categorial information about the garment. Some examples of these features include: (1) the type of the garment at (e.g. top, bottom, outerwear). (2) the dimensions of the garment (sleeve length, torso length, etc.). (3) Whether the garment has certain attributes (e.g., sleeve, sling, etc.).

Not all of the other features are required, and some may be unavailable at times. But having more of these features available helps the network produce better quality outputs. Note that when applying the spatial transformation to the neural garment image, one is required to perform the same spatial transformation to the features that are directly derived from the neutral garment image.

Human Body Features. The human body representation B consists of a full body person image b, ideally taken in a studio setting, the semantic layout (or human parsing) mask bₘ, the body pose representation bₚ, the garment key points computed on the person K, and other features.

The semantic layout mask bₘ is a segmentation mask of the person wearing the garment. The semantic layout mask is primarily used on the occluded part of the body and provides guidance for skin generation. The segmentation classes should at least be able to distinguish body skin, different pieces of garments and shoes, and the background. In the preferred embodiment of this invention, we work with the following classes: background, hair, face, neckline, right arm, left arm, right shoe, left shoe, right leg, left leg, bottoms, full body, tops, outerwear, bags, belly. The body pose representation bₚ can be a different form of body representation in the form of key points, 3D priors or others. As the pose representation revealing garment worn on the body presents challenges, we recommend simple pose representations which are less biased by the garment. In the preferred embodiment, we use OpenPose— a real-time multi-person keypoint detection library for body, face, hands, and foot estimation.

In the preferred embodiment, we use garment key points on the person K as the controllable intermediate representation to guide garment warping and enable adjustment to garment dimension and its position on the person. We compute the ground truth key points used during training through DeepFashion2— a comprehensive fashion dataset. During inference, the garment key points K are computed from the garment representation A and the body pose bₚ. Other categorical or numerical features include skin color, gender, body type, etc. They are helpful for user experience but optional.

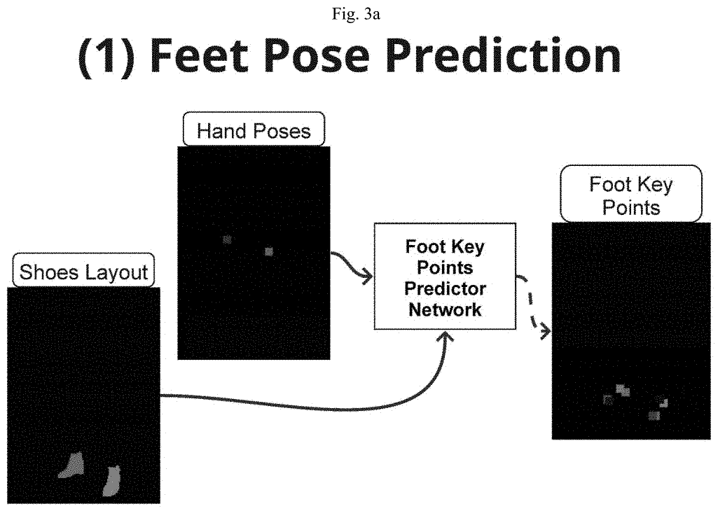

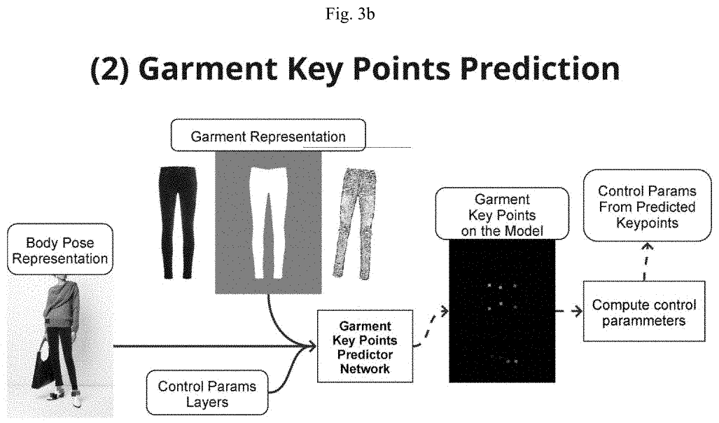

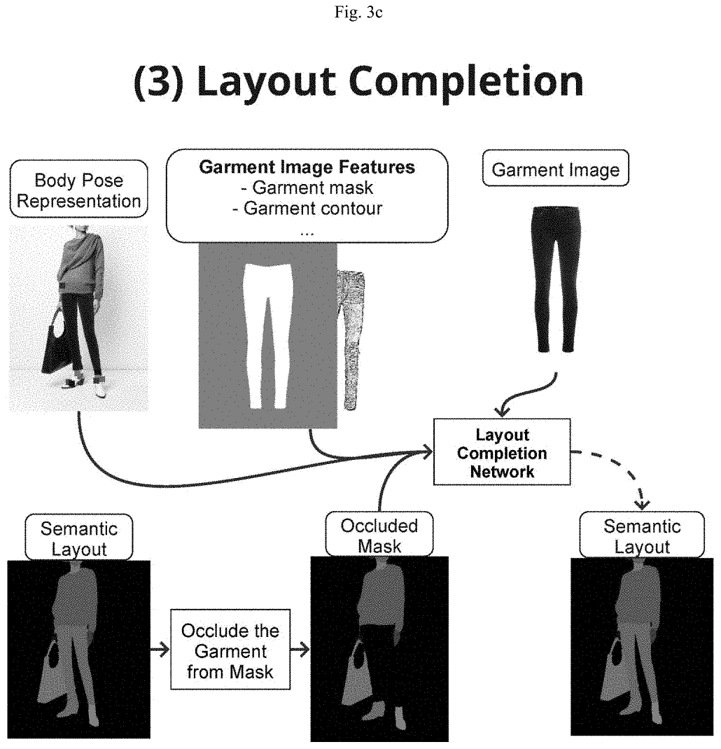

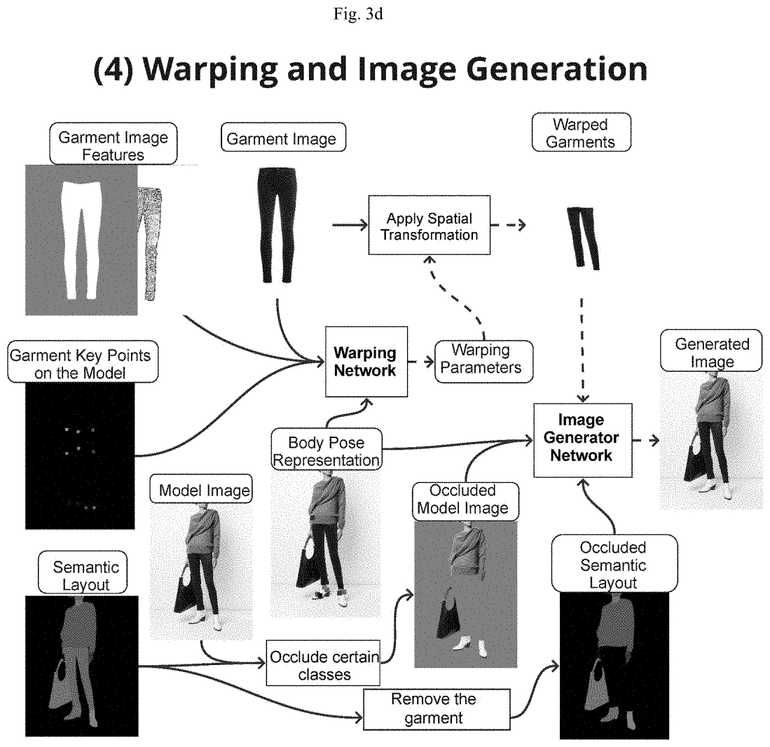

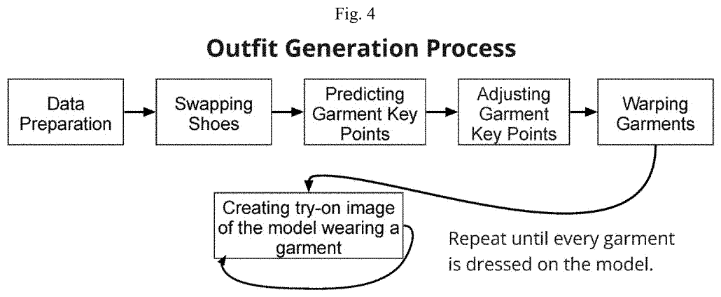

Networks Training Procedure. The system consists of several neural networks, each trained to perform a specific task in the generation process, as shown in FIGS. 3a-3d. The neural networks include the Feet Pose Predictor Network, the Garment Key Points Predictor Network, the Layout Completion Network, the Warping Network, and the Image Generator Network.

The Feet Pose Predictor Network G_{f} predicts key points of the feet based on the silhouette of a pair of shoes in a standing position.

The Garment Key Points Predictor Network Gₖ predicts the key points indicating each garment's position on the model based on the upper body pose representation, the feet key points, the neutral garment images, and the garment metadata derived from it.

The Layout Completion Network G₁ predicts the missing region of an incomplete semantic layout of the model with the target garments and other body parts occluded.

The Warping Network G_{w} produces spatial transformation from the neutral garment image to a warp that aligns the garment on the model based on the upper body key points, the feet key points and the garment key points, and other metadata.

The Image Generator Network Gᵢ produces the final image of the model wearing the outfit based on an input image with the garment and certain body parts occluded, a semantic layout with the garment occluded, the warped garment, and other metadata.

We will now describe in detail the training process for each of the components above.

Feet Pose Predictor Network. Because our system works with shoes that are placed in a standing position, placement of the shoes affects the standing pose of the body. Thus, when swapping a pair of shoes on the model, the body pose representation bₚ has to be updated to match the position of the new shoes. Thus, we train the Feet Pose Predictor Network G_{f} to predict the key points of the feet based on the silhouette of a pair of shoes in a standing position.

To train G_{f}, we obtain images b of models wearing full outfits (including shoes). From these images, we compute the body pose bₚ and semantic layout mask bₘ. We extract the shoes layout bₘ^{s} from bₘ and separate the feet key points from other key points in bₚ to obtain body representation without feet bₚ^{f-} and feet key points bₚ^{f}.

The Feet Pose Predictor G_{f} takes in the shoes layout bₘ^{s} and the body representation without feet bₚ^{f-} as input, and learns to predict the feet key points G_{f}(bₘ^{s}, bₚ^{f-}). The input body pose key points without feet bₘ^{f-}={k₁, . . . kₙ}, kᵢ=(xᵢ, yⱼ) are a list of points with x, y coordinates. We plotted every point k onto a 2D feature map with the same width and height as the shoe layout map bₘ^{s}, with square of constant width and height. Each key point takes a separate channel to avoid overlapping. All the key point 2D maps are then concatenated with the shoes layout and fed into the network. The network architecture can be of any encoder network which is designed to take in an image and produce a vector embedding. In the preferred embodiment, we use ResNet32 connected to a fully connected layer to produce bₚ^{f}′ of the shape N×8×2 (with the x and y coordinates of each of the 8 feet key points and the batch size N).

The network is trained using a L₁ loss and L₂ loss computed between bₚ^{f}′ and bₚ^{f}. To encourage structural consistency, we compute a matrix of distance between each pair of points

$$D = [ \begin{matrix}d ( {k}_{1} , {k}_{1} ) & d ( {k}_{1} , {k}_{2} ) & … & d ( {k}_{1} , {k}_{n} ) \\ d ( {k}_{2} , {k}_{1} ) & d ( {k}_{2} , {k}_{2} ) & … & d ( {k}_{2} , {k}_{n} ) \\ ⋮ & ⋮ & ⋮ & ⋮ \\ d ( {k}_{n} , {k}_{1} ) & d ( {k}_{n} , {k}_{2} ) & … & d ( {k}_{n} , {k}_{n} )\end{matrix} ]$$

where d(kᵢ, kⱼ)=\sqrt{|xᵢ−xⱼ|²+|yᵢ−yⱼ|2} and train the network to minimize the structural consistency loss Lₛ=∥D-D′∥. The total training for G_{f} can be written as

L_{Gf}=λ₁L₁+λ₂L₂+λ₃Lₛ (1)

where λ₁, λ₂, and λ₃ are the weights for each component.

Key Points Predictor Network. The Key Points Predictor Network Gₖ predicts the likely position and dimension of the garment on the person in the form of key points K={k₁, k₂, . . . , kₙ}, kᵢ=(xᵢ, yᵢ). As discussed earlier, the garment key points serve as the controllable intermediate representation that is easily modifiable. Our system can adjust the way the garments align on the body by modifying the x and y coordinates of one or multiple key points. The predicted output can also be directly used to generate an Outfit without modification, but modification is sometime required to address certain artifacts or to respond to certain user inputs.

We apply the pre-trained DeepFashion2 network to person images b to obtain the ground truth key points K for training. We require each b in the dataset to be paired with a garment representation A (such paired dataset can be easily acquired on a fashion retailer's website). The garment category metadata aₜ in A allows us to identify the garment key point K, that corresponds to the garment A, (as a person b may be wearing multiple garments).

In addition, we incorporate control parameters Z to specify the dimension and the shape of the garment. This is helpful because there are center shape attributes that are difficult to accurately infer from the neutral garment image. Z=[z₁, z₂, . . . , zₙ] is an array of numbers, each representing a certain shape property of the garment. Some parameters include the length of the torso, the width of the skirt/dress, the length between trouser leg and the ankle, the distance between the sleeve and the wrist, the depth of the neckline, the width of the neckline, the width of the trouser leg, the relative position between the neckline and the chin, etc. In some of these control parameters, we use body key points as references. To obtain ground truth control parameters for training, we apply the function Z=f_{z}(K, bₚ) and measure them through the ground truth key points K using ground truth body pose bₚ as reference. The control parameters should be chosen such that they are largely invariant when a person is standing in a natural pose, such that the ground truth control parameters Z inferred from the training data is generalizable to the garment paired with different models.

The control parameter Z serves as an optional input. When Z is not provided, Gₖ should make its best estimates of the garment dimensions; when Z is provided, Gₖ should strictly follow the dimension specified by the control parameters. Thus, during training, we feed in the control parameters as input half of the time and set them to zeros the other half of the time. When a control parameter is provided, we enforce an L_{z} as the L₂ distance between Z and the control parameter Z′ computed from the predicted key points K′. The loss encourages the network to predict an output that matches the provided control parameters.

The Key Points Predictor Network Gₖ takes in the garment representation A, the body pose representation bₚ, the control parameter Z, and outputs the garment key points K′=Gₖ (A, bₚ, Z). Note that Z was broadcast onto a 2D plane of the same size as bₚ and concatenated with other inputs. Gₖ uses the identical architecture of G_{f}, with the exception that its output is of the shape N×n×2 where N is the batch size and n is the number of key points. Following the training procedure of G_{f}, we train the network using L₁ loss, L₂, and the structure loss Lₛ computed between K′ and K. In addition, we compute the control parameter loss L_{z} described above. Note that not all then key points exist for every category of garment (e.g., tops do not have trouser leg key points). Thus, we apply a binary mask on the key points to filter out the non-existing key points and key point pairs before computing the training loss. The total training for Gₖ can be written as

L_{Gf}=λ₁L₁+λ₂L₂+λ₃Lₛ+λ₄L_{z} (2)

where λ₁, λ₂, λ₃ and λ₄ are the weights for each part of the loss.

Layout Completion Network. The Semantic Layout Completion Gₘ predicts the human parsing indicating the pixel region of garments and body parts on the generated try-on image.

To train Gₘ, we obtain the garment presentation A, the model's body pose bₚ, the garment key points K and the occluded semantic layout mask \hat{b}ₘ. Gₘ's training objective is to complete the missing regions of \hat{b}ₘ to reconstruct bₘ. The occluded mask \hat{b}ₘ is obtained by replacing parts of bₘ by background class through an occlusion function \hat{b}ₘ=fₒ(bₘ, aₜ). The occlusion function ƒₒ operates based on the garment category aₜ. In practice, fₒ may be implemented differently according to the classes that are presented in the semantic layout, but it should be guided by the following rules: (1)fₒ always replaces the region of the specified garment category aₜ; (2) fₒ also replaces the category of skin classes that are directly connected with aₜ. For example, when aₜ is tops, fₒ removes the arm layouts and the neckline layout, but not the legs layout. Gₘ is trained through pixel-wise Cross-Entropy loss and adopts a U-Net architecture because the skip connections help retains the provided part of the semantic layout.

Warping Network and Image Generator Network. The Warping Network G_{w} aligns the neutral garments to the model following the garment key points, and the Image Generator Network Gᵢ produces the final output image. G_{w} and Gᵢ are trained jointly but are applied separately during the inference phase.

G_{w} takes in the body pose representation bₚ, the garment representation A, and the garment key points K, and outputs the transformation parameters θ=G_{w} (bₚ, A, K). We apply the spatial transformation through θ to obtain the warped garment features W=w, wₘ, w_{c}, wₑ (w is the warped garment image; wₘ is the warped garment mask; wₑ is the warped garment cropped mask; We is the warped garment edge map). Our system can work with any warping method available (e.g. Affine Transformation, Thin-Spline Transformation, Optical Flow, etc.), as well as with future iterations that have a similar formulation. The main learning objective of the warper would be to minimize the difference in appearance between the warped garment and the region of the warp on the person. We write the warping loss as L. Note that the exact implementation of the training loss will differ based on the chosen warper, as different spatial transformations and network architectures require different regularization loss and sets of hyper parameters.

Gᵢ produces the final try-on image b′=Gᵢ(W, b0ₚ, bₒ, bₘ^{g}) based on the warped garment features W, the body pose representation bₚ, the occluded person image bₒ and the input semantic mask bₘ^{g}=bₘ⊙(1−b_{g}) without the to garment's layout b_{g}. The occluded person image bₒ is created by applying the occluded semantic layout mask \hat{b}ₘ produced by fₒ to the person image b. We remove the garment mask from the semantic layout bₘ because the garment warp provided through a separate channel may not exactly match the ground truth mask. Removing the garment mask allows Gᵢ to figure out the garment shape through the warp W, which often yields better results.

We recommend the architecture of Gᵢ to be any variant of U-Net as the skip connections provide an easy way to copy the provided input image. The learning objective is to produce an image that resembles the ground truth model and appears realistic. Thus, we train the network with an L₁ loss and L_{perc} Perceptual Loss computed between bₒ and b. In addition, we train Gᵢ with an adversarial loss L_{adv} to encourage realism of the output image. The total training for G_{w} and Gᵢ can be written as

L_{Gf}=λ₁L₁+λ₂L_{perc}+λ₃L_{adv}+λ₄L_{w} (3)

where λ₁, λ₂, λ₃ and λ₄ are the weights for each part of the loss.

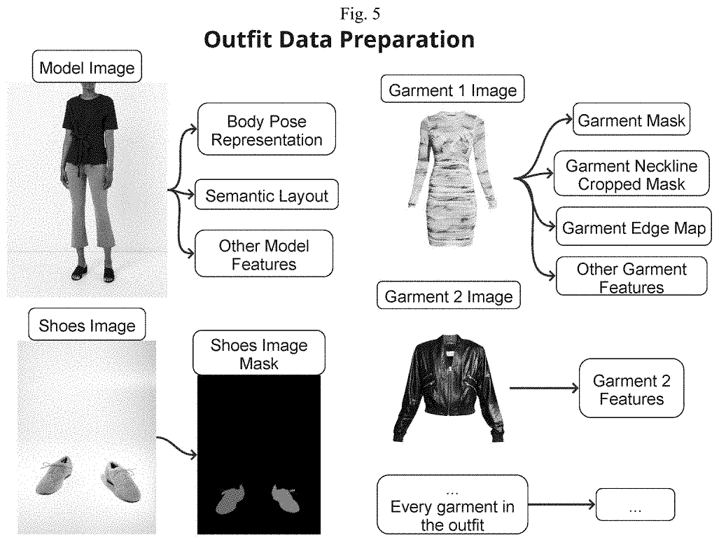

Outfit Generation Procedure. This section describes the process of generating an Outfit with garments {a₁, a₂, . . . , aₒ}, shoes s and model image b. As shown in FIG. 4, the process starts by computing the feature representations of the model B and the feature representations for every garment {A₁, A₂, . . . , Aₒ}. When there is a pair of shoes to be swapped, the method swaps the original shoes on the model with the new shoes, and updates the person image b, the semantic layout bₘ, and the body pose representation bₚ 's feet key points according to the new shoes s. Then, the Garment Key Points Prediction Network Gₖ computes the garment key points on the person {K₁, K₂ . . . , Kₒ} for every item in the outfit. The garment key points are updated by a function ƒₘ consisting of a set of heuristics and optionally human intervention, resulting in the updated set of garment key points {\hat{K}₁, K₂, . . . , Kₒ}=fₘ({K₁, K₂ . . . , Kₒ}, bₚ). The Warping Network G_{w} computes the transformation parameters {θ₁, θ₂, . . . , θₒ} for every garment based on the adjusted key points. These transformation parameters enable us to compute the warped garment feature {W₁, W₂, . . . , Wₒ}.

The try-on process is a sequential process that produces a try-on image for every garment in the outfit one aₜ a time. During each step, the process consumes the warped garment features W, the adjusted key points \hat{K}, and the model metadata B with the updated shoes, if provided, and outputs an image of the model b′ wearing warped garment W, as well as the updated human representation B′. The subsequent step would work with the updated person representation B′ instead of the original on B. The process always starts with the garment beneath and then overlays the next garment on top of the previous image (e.g. the top always goes on before outerwear). The process is slightly different for different types of garments.

Outfit Data Preparation. The outfit generation process begins with outfit data preparation. One should obtain a full-body image of the model b. The model should be in a casual standing pose, with both arms hanging down naturally. The photo should ideally be taken with a studio lighting. Ideally, the model should wear garments which simplify the process of extracting the body pose representation. If the shoes on the model are to appear on the try-on image, one should ensure that the shoes are not occluded by the garments. Once the model image b has been finalized, one should extract the body pose representation bₚ, the semantic layout mask bₘ, and other model metadata following the training procedure. For each garment in the outfit, one should obtain a neutral garment image a. The image should ideally be taken in the format of a ghost mannequin image or a flat-lay image. It is also possible to use garment images taken on a person as long as the garment has not been heavily distorted. For each garment, one should also produce an identical set of garment features and metadata.

Providing a pair of shoes s is optional. When the shoes are not provided, the model will keep its original shoes, and the outfit generation process will skip the Swapping Shoes step (described below). To provide a pair of shoes, one should prepare a photograph of shoes taken in a natural standing position as if the shoes were worn by a person. The camera angle should resemble that of the model images b used during training so that the networks can generalize well. After the photo is taken, one should produce a shoes' mask bₘ^{s} that crops out the shoes from the background. One should also remove the part of the shoes that will be occluded when a foot is present to match the training distribution. If both shoes are identical, one has the option of photographing a single shoe and inverting it, assuming the lighting can be taken care of to make both shoes look realistic. When both of the shoes' images s and the mask bₘ^{s} are ready, one should place them in an image of the identical size as the model image b. The position and size of both shoes and the distance between the shoes should be properly adjusted to fit the size and position of the body in b.

Swapping Shoes. We swap the shoes before working with the garments. The shoes will remain static once placed on the model, throughout the whole try-on process. As the position of the feet is defined by the shoes, it is beneficial to swap the shoes before the garments and have the garments adapt to the shoes' positions.

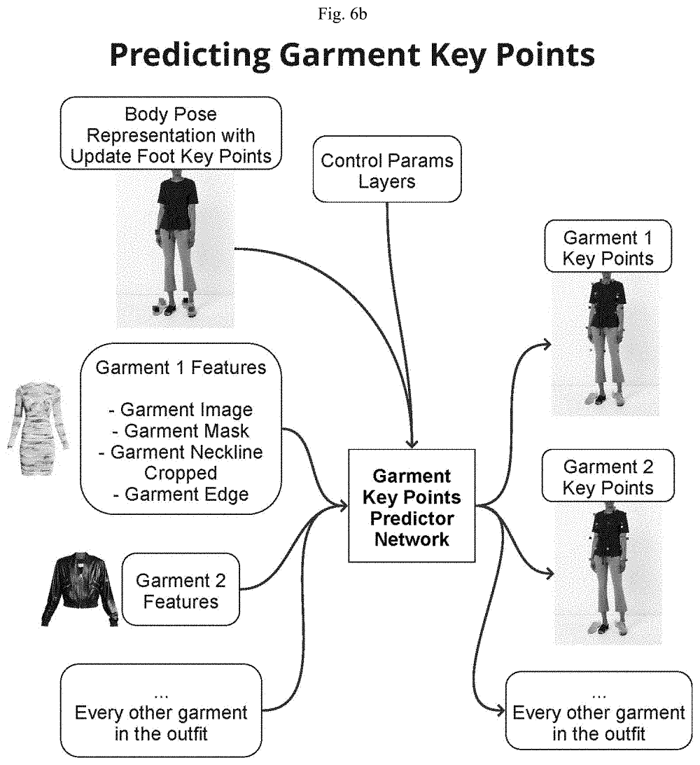

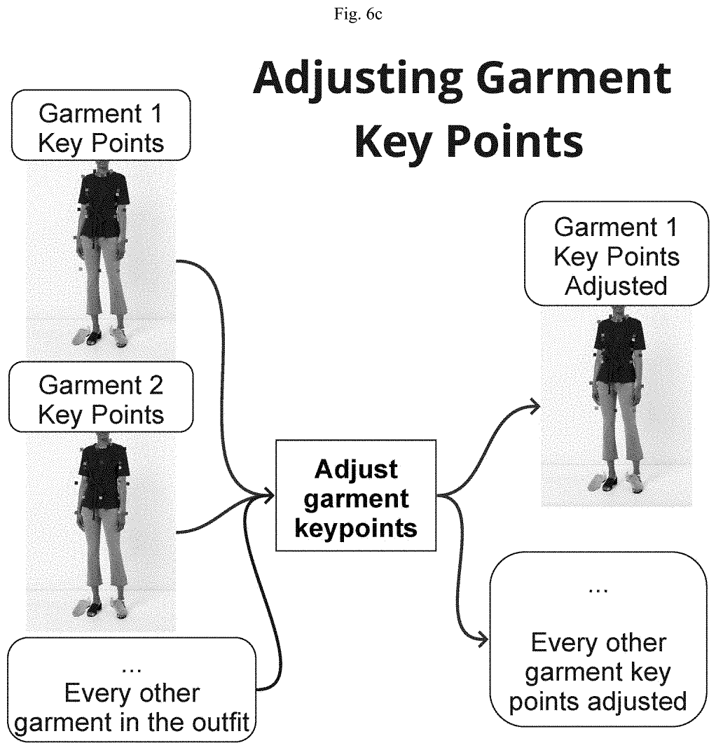

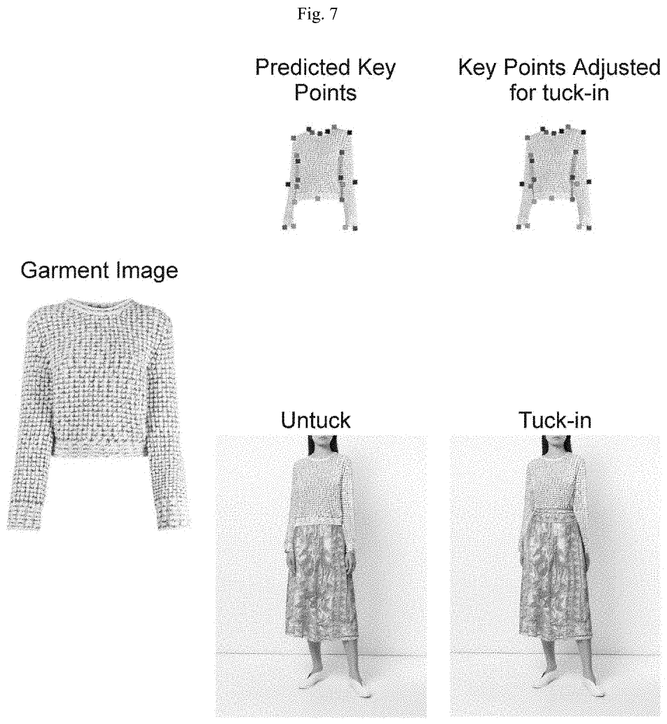

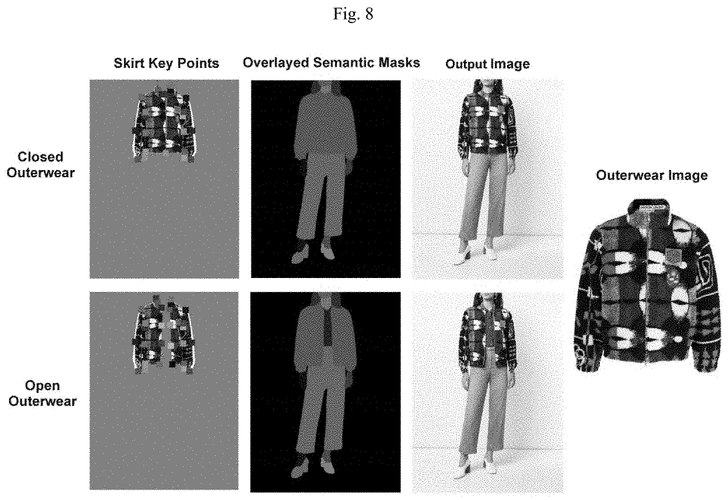

As shown in FIG. 6, the shoes' mask bₛ^{m} and the body pose representation by without the feet key points are fed into the Feet Pose Predictor Network G_{f} to obtain the feet key points bₚ^{f} that match the placement of the shoes. The body pose representation bₚ is updated with the newly predicted feet key points bₚ^{f}, resulting in b′ₚ. The original semantic layout bₘ has the shoes classes set to the background class. Subsequently, the shoes' mask bₘ^{s} is overlayed on top of the human parsing, resulting in the updated b′ₘ with the new shoes masks. The image of the shoes is cropped out and overlayed on top of the model image b, resulting in the updated model image b′=b⊙(1−bₘ^{s})+s⊙bₘ^{s}

Predicting Garment Key Points. The system predicts garment key points on the model, providing guidance on how each garment should be placed on the model. The prediction is a general estimation made based on the garment metadata A and the person's pose updated with the new foot pose b′ₚ, and is subject to change.

The Garment Key Points Predictor Network Gₖ takes in the garment representation A for each garment in the outfit, the updated body pose representation b′ₚ, and the garment dimension control parameters Z for the specific garment, and outputs garment key points on the model for each garment {K₁, K₂ . . . , Kₒ}, Kᵢ=Gₖ(Aᵢ, b′ₚ, Z).

Adjusting Garment Key Points. Adjusting the garment key points is not mandatory because the predicted key points may be accurate in some instances. However, when the user wants the garment to be worn in a specific way, we can achieve the effect by adjusting the key points. Other reasons to adjust the key points is to coordinate multiple garments, as their position may not be perfectly coordinated (because they are predicted individually). All the garment key points {K₁, K₂ . . . , Kₒ} are fed into the function ƒₘ which makes an automatic adjustment according to a set of heuristics and outputs the adjusted set of key points {K₁′, K₂′, . . . , Kₒ′,} The heuristics can be customized based on the type of the garments or specific needs and can be frequently updated. In this section, we will describe several examples of key point adjustments that are useful.

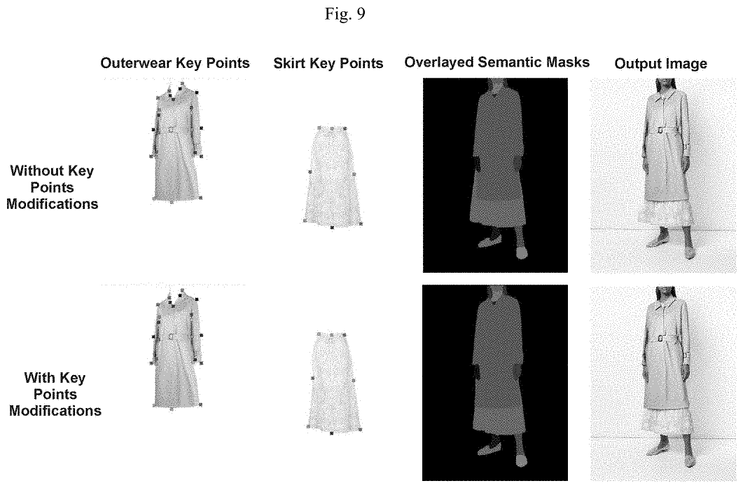

Tuck-in vs. Untuck. We can modify the key points of tops to achieve a tucked-in versus untucked effect. As shown in FIG. 7, the top key points predicted from the network Gₖ have the shape that is suitable for the untucked style. To modify the shape such that it is suitable for a tucked-in fit, we move the three key points at the bottom of the torso upward for roughly 5 cm (1.9 in), and move the left and right key points toward the center for roughly 5 cm (1.9 in). This results in the torso part of the top appearing narrower, creating the effect of being squished by the bottoms. The checked sweater in FIG. 7 clearly shows how the fabric of the top is draped naturally following the key points adjustments.

Split Outerwear. The key points allow us to split the garment into multiple pieces and warp each of them separately. This allows more dynamic ways to wear a garment—such as searing an outerwear as split.

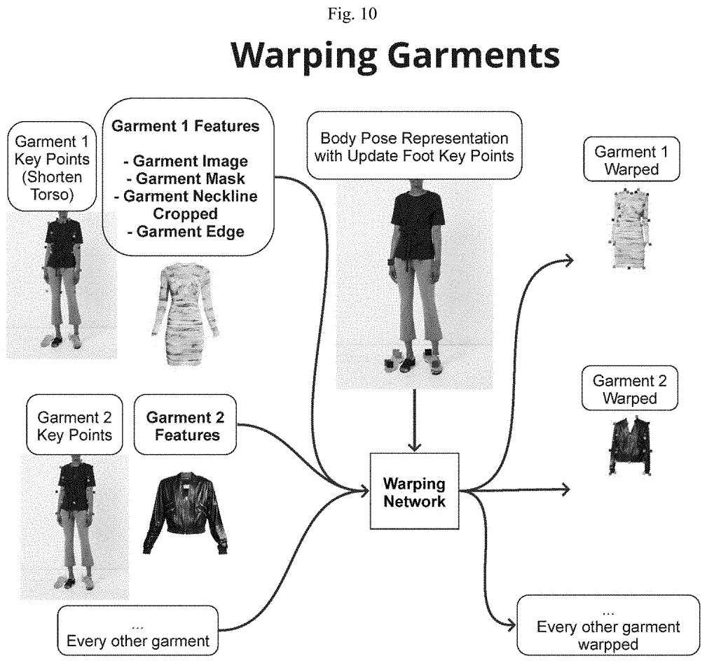

FIG. 8 shows an example of a open vs. closed outerwear, controlled by the key points. Note that in the open outerwear scenario, we divide the garment representation of an outerwear into left garment A^{l} and right garment A^{r}. The key points are also divided into the left component K^{l} and the right component KC. The warper predicts the spatial transformation parameter for the left side as θ¹=G_{w} (bₚ, A^{l}, K^{l}) and for the right side as θ^{r}=G_{w} (bₚ, A^{r}, K^{r}). Finally, both sides of the warps are merged into a single warped image and fed into the image generator Gᵢ.

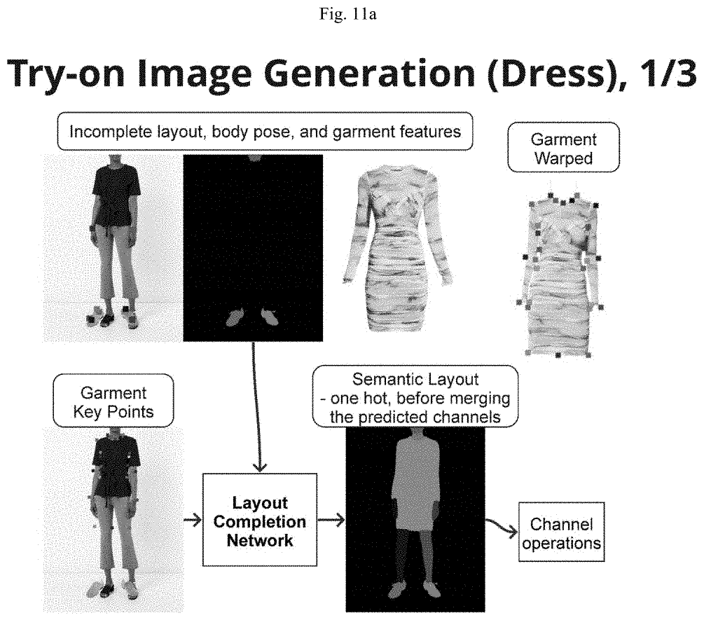

Coordinating Multiple Garments. Because the on-body key points of each individual garment are predicted separately, they may not coordinate well. FIG. 9 shows an example of such an error when the predicted region of the skirt stuck out of the long coat when it was not supposed to. These types of errors can be easily addressed through modifying garment key points. In the above example, the system addresses the error by drawing a line between the first and the second key on each side of the outerwear torso and shifting the position of the skirt such that it fall within the region. This adjustment results in the outerwear completely covering the skirt. This example shows how key points can be used to coordinate multiple garments to achieve the optimal rendering quality.

In practice, a person with ordinary skill in the art recognizes that it is obvious that variations of the function ƒₘ described above would address different types of errors or allow different ways for users to control the try-on output. We want to highlight the importance of using a controllable intermediate representation of the garment to enable such customizations.

Warping Garments. After the on-body position of every garment is finalized, the system aligns every garment onto the model. For every garment, G_{w} takes in the modified key points Kᵢ′, the garment representation A₁, the updated body pose representation bₚ′, and outputs the spatial transformation parameters θᵢ. We apply the spatial transformation to the garment image a₁ and other spatially aligned features (aₘ, a_{c}, and aₑ), resulting in the warped garment representation Wᵢ.

Creating a Try-on Image. We adopt an iterative process of producing try-on image for an Outfit—each step of the process puts one garment onto the model. The process always starts from the most inner garment and ends with the most outward garment (e.g., the jacket). At each step, the system takes one warped garment i (both the original garment Aᵢ and the warped one Wᵢ), the body pose bₚ and the updated model image and corresponding semantic layout mask (b′, bₘ′). The system then outputs image b″ of the model wearing the garment i and its corresponding semantic layout mask b″. Subsequently, (b″, b″ₘ) becomes the input to the system to put on the next garment j, until all garments in the outfit are shown on the person.

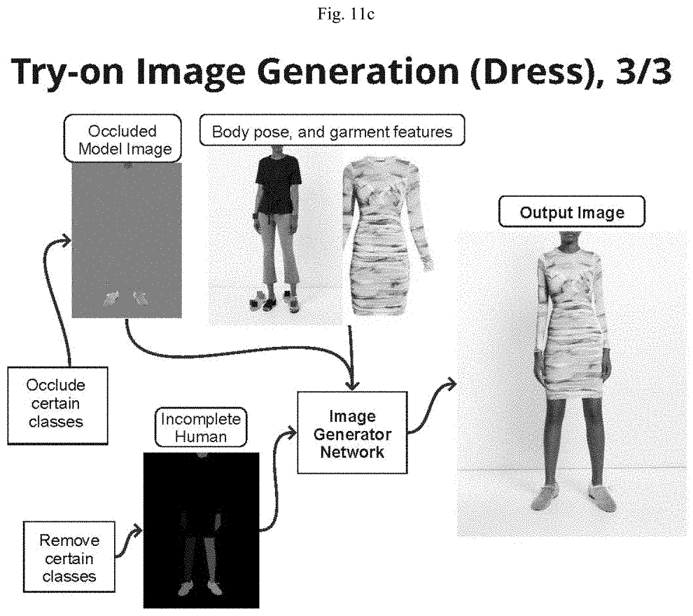

FIGS. 11a-11c show the process of rendering a dress onto a model. The system first produces the semantic layout mask of the model wearing the new garment through the Layout Completion Network G₁. Since the predicted semantic layout is not accurate to shape, we do not use the garment shape from the predicted mask but obtain it from the warped garment W instead. The predicted semantic layout mask and the garment warp W are merged to obtain the final occlusion layout mask [symbol] used to occlude the latest model image b′ₘ. Finally, the image generator Gᵢ produces the output try-on image b″ using the partially occluded image \hat{b}, the occlusion layout mask [symbol] , and the warped garment features W.

Obtaining the Occlusion Mask. The Layout Completion Network G₁ takes in the body pose representation bₚ, the partially occluded layout [symbol] , obtained by setting certain classes as background (following the training procedure) and the garment representation A and outputs the layout of the model wearing the designated garment b″ₘ. Note that the final output layout b″ₘ of shape N×1×H×W is obtained through performing f_{argmax}^{d=2}(B″ₘ) where B″ₘ of shape N×C×H×W is the output of the last Softmax layer of the Gᵢ network (N is the batch size, C is the total number of classes the semantic layout mask has; H is the pixel height; W is the pixel weight).

For the region in b″ₘ that has the garment class b″ₘ^{g}, we perform a set of operations based on Softmax output Bₘ″ and some other heuristics to infer the second most likely class (rather than the garment). It is necessary to find the second most likely class of the region because the warped garment mask bₘ^{w} may not exactly match the garment region predicted by b″ₘ. Thus, directly overlaying bₘ^{w} on top b″ₘ may result in gaps in the semantic layout. Knowing the second most likely class helps filling in possible gaps.

The Second Most Likely Class. From the Softmax output B″ₘ, we first set the value of the channel that corresponds to the garment to zero, removing it completely. We evaluate each human body class and constrain the region that it should appear in and set the reset of the region to zeros. For example, the leg should not appear above the waist, so we set the above waist region of the leg channels to zeros; the neckline class should not appear below the chest, so we set the below check region of the neckline channel to zeros. Specific rules can be inferred based on the set of human body classes that are presented. After all the heuristics are applied, we obtain the modified B″ₘ^{r}. We perform argmax on the second dimension to obtain b″ₘ^{r}=f_{argmax}^{d=2}(B″ₘ^{r}). Finally, the ready-to-merge mask b″ₘ^{f} obtained by b″ₘ^{r}=(1−b″ₘ^{g})⊙b″ₘ+b″ₘ^{g}⊙b″ₘ^{r}.

Merging Warp Mask with Layout Mask. Obtaining the occlusion layout mask [symbol] involves merging the predicted mask b″ₘ^{s} with the garment warp mask bₘ^{w} and performing the occlusion procedure during the training. The warped garment mask bₘ^{w} is part of W obtained by the warping of the cropped garment mask a_{c}. We merge b″ₘ^{s} and bₘ^{w} to obtain the merged mask b″ₘ^{m}=b″ₘ^{s}⊙(1−bₘ^{w})+aₜ·bₘ^{w} where aₜ is the value of the garment class. The merged mask b″ₘ^{m} is the final semantic layout mask that will be output along with the generated image b″. Finally, we perform the occlusion procedure on the merged mask b″ₘ^{m} to obtain the occlusion layout

[symbol]

Finally, the Image Generator Gᵢ produces the output image b″ of the model wearing the garment based on the occluded layout mask [symbol] the Occluded Model image, the body pose b′ₚ and the warped garment W. In the preferred embodiment, the Image Generator Gᵢ allows optional control parameters to specify the skin tones, ethnicity, body size, facial expression, hair styles, and other aspect of the human body.

Miscellaneous. There are small differences for each category of garments based on some of their characteristics. For example, when a top is being tried on, the leg layout is kept identical as it is not expected to change. The order of steps in the try-on process may also be different based on how the garments should be worn. For example, when the top is tucked in, the tops will be processed before the bottoms because the top goes beneath the bottom; when the top is tucked out, the bottoms will be processed before the top, because the top covers the bottom. We leave such details out as they can be configured on a per-application basis (depending on what categories of garments are expected and the way they are worn).

What is claimed is:

1. A computer-implemented method for generating high-resolution digital try-on images of human models wearing arbitrary combinations of garments, the method comprising:
a. obtaining a human body representation;
b. obtaining neutral representations of garments;
c. taking steps to create a controllable intermediate representation that predicts the garments' spatial transformation on the body;
d. creating a semantic layout of the body wearing the garments;
e. using a spatial transform estimation procedure to create a representation of garments as worn on the body;
f. generating a synthesized image depicting the body wearing a combination of the garments with faithfully represented spatial interrelationships and transformation using an image generator.

2. A system of claim 1 incorporated into a real-time interactive user interface.

3. The method of claim 2, wherein the controllable intermediate representation can be adjusted by human intervention.

4. The method as recited in claim 2, allowing for the generation of images depicting lower portions of tops as inserted (tucked) in bottoms.

5. The method of claim 2, allowing for the generation of images depicting a combination of garments with closed or open outerwear.

6. The method of claim 2, allowing control to the skin tones, ethnicity, body size, facial expression, hair styles, or other aspect of the human body in the generated image.

7. The method as recited in claim 1, wherein the controllable intermediate representation is predicted by computing key points on said garments.

8. The method as recited in claim 1, wherein the neutral garment representations are 2D photographs of garments lying down or hanging.

9. The method as recited in claim 1, wherein the garments and other objects placed on top of the human body include the following classes: tops, bottoms, dresses, outerwear, and bags.

10. The method of claim 1, allowing for use of body representations of different types, including different heights, body types, and skin colors.

11. The method of claim 1, wherein garment deformations on the body are influenced by the garment's fabric properties.

12. The method of claim 1, wherein an outfit with multiple garments is rendered in sequence that starts with the garments beneath and end with the outer garment on top.

13. A computer-implemented method for generating high-resolution digital try-on images of human models wearing arbitrary combinations of garments and shoes, the method comprising:
a. obtaining a human body representation and a representation of a pair of shoes;
b. computing a new body pose representation to match the shoes' position using a body pose predictor;
c. obtaining neutral representations of garments;
d. taking steps to create a controllable intermediate representation that predicts the garments' spatial transformation on the body;
e. creating a semantic layout of the body wearing the garments;
f. using a spatial transform estimation procedure to create a representation of garments as worn on the body;
g. generating a synthesized image depicting the body wearing a combination of the garments with faithfully represented spatial interrelationships and transformation using an image generator.

14. A system of claim 13 incorporated into a real-time interactive user interface.

15. The method of claim 14, wherein the controllable intermediate representation can be adjusted by human intervention.

16. The method as recited in claim 14, allowing for the generation of images depicting lower portions of tops as inserted (tucked) in bottoms.

17. The method of claim 14, allowing for the generation of images depicting a combination of garments with closed or open outerwear.

18. The method of claim 14, allowing control to the skin tones, ethnicity, body size, facial expression, hair styles, or other aspect of the human body in the generated image.

19. The method as recited in claim 13, wherein the controllable intermediate representation is predicted by computing key points on said garments and said shoes.

20. The method as recited in claim 13, wherein the neutral garment representations are 2D photographs of garments lying down or hanging.

21. The method as recited in claim 13, wherein the body representation is configured according to the shoes representation.

22. The method as recited in claim 13, wherein the representation of a pair of shoes is obtained from a representation of a single shoe.

23. The method as recited in claim 13, wherein the garments and other objects placed on top of the human body include the following classes: tops, bottoms, dresses, outerwear, shoes, and bags.

24. The method of claim 13, allowing for use of body representations of different types, including different heights, body types, and skin colors.

25. The method of claim 13, wherein garment deformations on the body are influenced by the garment's fabric properties.

26. The method of claim 13, wherein an outfit with multiple garments is rendered in sequence that starts with the garments beneath and end with the outer garment on top.
